(19) United States
(12) Patent Application Publication
(10) Pub. No.: US 2024/0201699 A1
(43) Pub. Date: Jun. 20, 2024

(54) Remote Pilot and Driver Assist System and Method

(71) Applicant: Urban Robotics, Inc., Las Vegas, NV (US)

(72) Inventors: Anand Nandakumar Raghav, Las Vegas, NV (US); Kevin Alexander Keogh, Las Vegas, NV (US); Lukas Hadiyanto Herman, Las Vegas, NV (US); Mithun Manivannan, Las Vegas, NV (US)

(21) Appl. No.: 18/514,786

(22) Filed: Nov. 20, 2023

Related U.S. Application Data
(63) Continuation of application No. PCT/US2022/030601, filed on May 23, 2022.
(60) Provisional application No. 63/191,892, filed on May 21, 2021.

(51) Int. Cl. G05D 1/227

(52) U.S. Cl. CPC G05D 1/227

(57) ABSTRACT

A remote pilot and driver assist system and methods is disclosed. In some embodiments, the remote pilot and driver assist system and methods may be used to safely navigate a vehicle to a desired destination. The remote pilot and driver assist system and methods may include a driver assist application and a data store running on an application server and wherein the application server is in communication with one or more vehicles, one or more local users or drivers, and one or more remote pilots using their remote pilot terminals.

### FIELD OF THE INVENTION

The subject matter relates generally to transportation systems and more particularly to a remote pilot and driver assist system and methods for safely navigating a vehicle to a desired destination.

### BACKGROUND OF THE INVENTION

With the advent of ride hailing services, people have enjoyed increase options for easily navigating to a desired location. While convenient for end-users, the need to engage with a driver for the duration of a trip as well as down time of drivers between trips has led to inefficiencies in traditional ride haling companies.

Further, real-time video/audio streaming applications require stable latency and enough bandwidth to forward the packets. In a stationary environment, latency and bandwidth are somewhat predictable, the signal strength from a device to Wi-Fi doesn't change much, and even less so if the device is wired. Whereas in a mobile environment, signal strength can drop at any time depending on how far the device is from many factors such as nearby antennas, surrounding interference. In critical real-time systems, such as robotic teleoperation, small latency spikes can cause safety hazards.

### SUMMARY

A first aspect of the disclosure includes a method of remotely and locally driving a vehicle. The method comprises receiving, by the vehicle, remote navigation commands from a remote pilot terminal. The method comprises controlling one or more navigation controls on the vehicle using the remote navigation commands. The method comprises transitioning from remote navigation control from the remote pilot terminal to local user control of the vehicle. The method comprises, upon transitioning to local user control, receiving manual control of the one or more navigation controls on the vehicle from the local user.

In some implementations, the method further comprises authenticating and/or verifying the remote navigation commands prior to controlling the one or more navigation controls on the vehicle using the remote navigation commands.

In some implementations, the method further comprises sensing, via one or more sensors, an environment surrounding the vehicle. The method further comprises locally determining by the vehicle, with a driver assist system, whether the vehicle is traveling along a safe path.

In some implementations, the method further comprises upon identification of an error, controlling, by the driver assist system, the one or more navigation controls on the vehicle to a minimum risk condition.

In some implementations, the error is selected from the group consisting of detecting an unsafe path, detecting an impending collision, detecting a communication error, detecting an error in one or more of the sensors, and detecting an obstacle in a planned path.

In some implementations, the minimum risk condition is selected from the group consisting of pulling the vehicle to the side of a road, stopping the vehicle in a lane, performing an emergency stop with the vehicle, and steering the vehicle around an obstacle.

In some implementations, the method further comprises communicating data regarding the environment surrounding the vehicle sense by the one or more sensors to the remote pilot terminal.

In some implementations, the data regarding the environment surrounding the vehicle is communicated via redundant round-robin communication across a plurality of independent wireless communication networks.

In some implementations, the method further comprises after transitioning to local user control, transitioning back to remote navigation control from a second remote pilot terminal.

In some implementations, the second remote pilot terminal is the same as the first remote pilot terminal.

A second aspect of the disclosure includes a locally and remotely controlled vehicle. The vehicle comprises a modem configured to communicate with a server via a plurality of independent communication networks. The vehicle comprises a plurality of sensors configured to detect an environment surrounding the vehicle. The vehicle comprises navigation controls configured to drive the vehicle, wherein the navigation controls are selectively controlled based on local user inputs or remote navigation commands. The vehicle comprises a controller communicatively coupled to the modem, the plurality of sensors, and the navigation controls. The controller is configured to communicate data from the sensors of the environment surrounding the vehicle to a remote pilot terminal in communication with the server. The controller is configured to receive the navigation controls from the remote pilot terminal. The controller is configured to receive a control transition command from the server or the vehicle to initiate local control of the navigation controls.

These and other features will be more clearly understood from the following detailed description taken in conjunction with the accompanying drawings and claims.

### BRIEF DESCRIPTION OF DRAWINGS

Having thus described the subject matter of the present invention in general terms, reference will now be made to the accompanying drawings, which are not necessarily drawn to scale, and wherein:

FIG. 1 illustrates a block diagram of an example of the presently disclosed remote pilot and driver assist system suitable for implementing the several embodiments of the invention;

FIG. 2 illustrates a flow diagram of an example of a method of using the presently disclosed remote pilot and driver assist system, in accordance with an embodiment of the invention;

FIG. 3 illustrates a high-level block diagram of an example of a system safety platform of the remote pilot and driver assist system, in accordance with an embodiment of the invention;

FIG. 4A and FIG. 4B illustrates a block diagram showing more details of the system safety platform shown in FIG. 3, in accordance with an embodiment of the invention;

FIG. 5 shows pictorially an example of the operation and outputs of a halo shield system-portion of the system safety platform, in accordance with an embodiment of the invention;

FIG. 6 illustrates an example of a system safety flow timeline of the system safety platform, in accordance with an embodiment of the invention;

FIG. 7 illustrates a flow diagram an example of a logic check method using a system state arbiter of the system safety platform, in accordance with an embodiment of the invention;

FIG. 8 illustrates a block diagram of an example of an overall network architecture of the system safety platform, in accordance with an embodiment of the invention;

FIG. 9 illustrates a flow diagram of an example of a sender loop that may be used in the network configuration of the remote pilot and driver assist system, in accordance with an embodiment of the invention; and

FIG. 10 illustrates a flow diagram of an example of a receiver loop that may be used in the network configuration of the remote pilot and driver assist system, in accordance with an embodiment of the invention.

### DETAILED DESCRIPTION OF THE INVENTION

In some embodiments, the presently disclosed subject matter provides a remote pilot and driver assist system and methods for safely navigating a vehicle to a desired destination.

In some embodiments, the presently disclosed remote pilot and driver assist system and methods may be provided in a networked computing configuration that includes a driver assist application and a data store running on an application server.

In some embodiments, the presently disclosed remote pilot and driver assist system and methods may involve a driver assist application on an application server in communication with one or more vehicles, one or more local users or drivers, and one or more remote pilots using their remote pilot terminals.

In some embodiments, the presently disclosed remote pilot and driver assist system and methods may involve a driver assist application on an application server in communication with one or more vehicles capable of being driven remotely by remote pilots, driven autonomously using autonomous driver technology, and/or driven manually by local users.

In some embodiments, the presently disclosed remote pilot and driver assist system and methods may provide a driver assist application including a halo shield system, a system state arbiter, an emergency planner, and an actuation controller that form a system safety platform.

In some embodiments, the presently disclosed remote pilot and driver assist system and methods may provide a system safety platform operating on a system safety flow timeline that may be used to monitor the overall health of the remote pilot and driver assist system.

In some embodiments, the presently disclosed remote pilot and driver assist system and methods may provide a system safety platform operating on a system safety flow timeline that may include a functional timeframe, followed by a failure timeframe, followed by a detection timeframe, followed by a mitigation timeframe, followed by a response timeframe.

In some embodiments, the presently disclosed remote pilot and driver assist system and methods may provide a system safety platform operating on a system safety flow timeline in which the vehicle operates normally during the functional timeframe, but then in the event of a failure or error occurring, the halo shield system operates during the failure timeframe, the system state arbiter operates during the detection timeframe, the emergency planner operates during the mitigation timeframe, and the actuation controller operates during the response timeframe.

In some embodiments, the presently disclosed remote pilot and driver assist system and methods may provide at least three wireless communications networks for communicating with and vehicles for optimizing data processing, providing redundancy, and achieving high network reliability.

In some embodiments, the presently disclosed remote pilot and driver assist system and methods may provide at least three wireless communications networks for communicating with vehicles and in which data packets may be pushed to all three wireless communication networks (i.e., redundancy), then the data packet that arrives at its destination first (on any one of the three networks) gets consumed, while the remaining two data packets are shutout or ignored.

In some embodiments, the presently disclosed remote pilot and driver assist system and methods may provide at least three wireless communications networks for communicating with vehicles and in which a round-robin process in which data packets may be pushed to two of the wireless communication networks (i.e., redundancy), while not pushing data packets to the remaining one of the wireless communication networks.

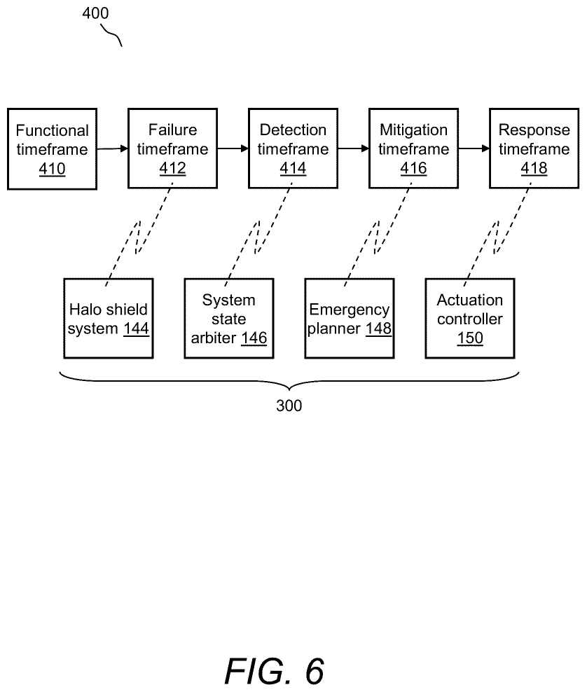

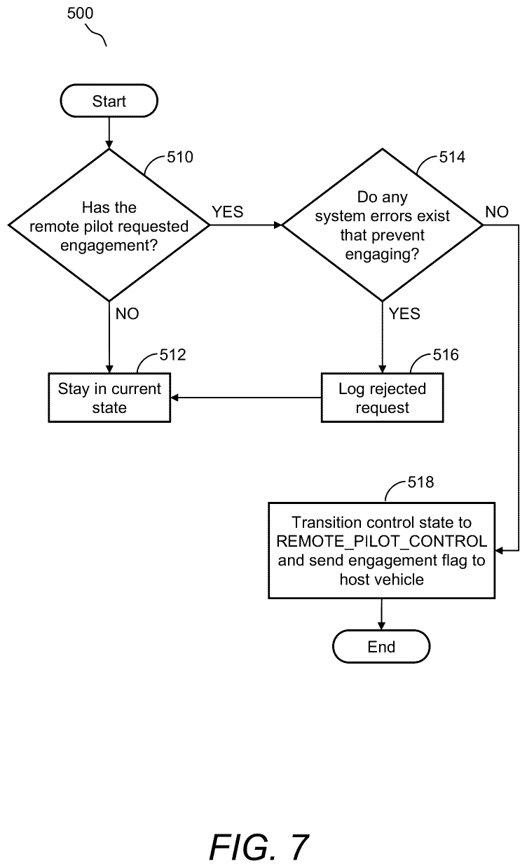

Compared with prior ride hailing services, a more efficient and safer ride hailing service and system are presented herein. For example, the presently disclosed remote pilot and on-board driver assist system and methods may be used to facilitate the safe navigation of a vehicle to a desired destination. The remote pilot maintains primary control over the vehicle via remote communication with navigation controls of the vehicle. For example, for a car, the navigation controls of the vehicle include the accelerator, brake, emergency break, turn signals, steering wheel, and the like. Using the navigation controls of the vehicle, the remote pilot may drive the vehicle to a target location (e.g., pick up location of an end user). The driver assist system monitors the local conditions and ensures that the remote pilot travels along a safe path. Additionally, the presently disclosed remote pilot and driver assist system and methods ensure that the vehicle travels to a minimum risk condition (e.g., pulls to the side of the road, stops in a lane, performs an emergency stop, etc.) in the event of an error, as detailed, for example, in FIG. 6 and FIG. 7.

In various implementations, the driver assist system may include an autonomous pilot. For known autonomously safe sections of a route between a current location of the vehicle and the target location, the autonomous pilot maintains primary control of the vehicle and drives the vehicle while the remote pilot supervises. On more difficult sections of the route or at will, the remote pilot takes primary control of the vehicle from the autonomous pilot and drives the vehicle. The remote pilot may continue to drive the vehicle to the target location or again cede control back to the autonomous pilot for additional sections of the route.

Upon reaching a target location, the remote pilot stops the vehicle to allow an end-user to assume control of the vehicle. The end-user takes control of the vehicle and drives to a desired destination. In various implementations, the end-user may take control of the vehicle through an acknowledgement on an application on the end-user's mobile device and/or an acknowledgement in the vehicle. In some implementations upon the end-user taking control of the vehicle, the remote pilot may be prevented from taking control of the vehicle. In some implementations, the remote pilot may take control of the vehicle upon detecting unsafe operation of the vehicle (e.g., upon an alert being triggered by the driver assist system).

In some implementations, upon the end-user entering the vehicle, the remote pilot may maintain control of the vehicle. For example, upon payment of an additional cost, the remote pilot, together or separate from the autonomous pilot, may drive the vehicle to the desired destination. In some implementations, the end-user may be prevented from providing input to the vehicle navigation controls while the remote pilot is driving the vehicle (e.g., steering wheel inputs from the end-user may be ignored). In some implementations, end-user inputs to the vehicle navigation controls may override controls from the remote pilot so long as they do not cause an error with the driver assist system (e.g., the driver assist system prevents the vehicle from following a path determined not to be safe).

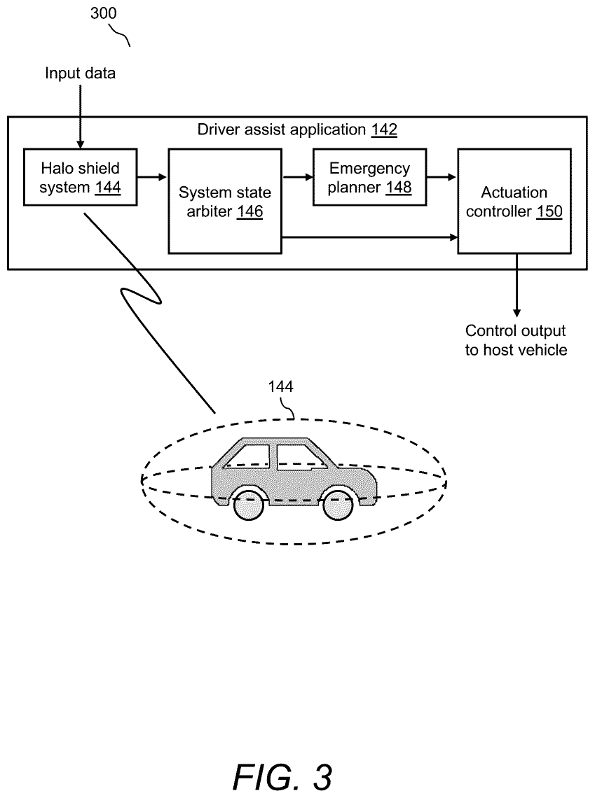

Upon reaching the desired destination, the end-user may cede control back to the remote pilot and exit the vehicle. The remote pilot may then navigate the vehicle (alone or with the autonomous pilot) to a next pick-up location or designated staging area for waiting for a next pick-up. Additional details of the safety systems and product flow are provided hereinbelow with reference to FIG. 3 through FIG. 6.

The pairing of a remote pilot with a local vehicle driver assist system and/or autonomous pilot may be used to facilitate improved navigation use cases. For example, in ride hailing services, the remote pilot is engaged with a vehicle only in the navigation to and from the end-user. Upon the end-user taking control of the vehicle, the remote pilot may assist with navigation of another vehicle. Therefore, a single remote pilot may facilitate driving multiple vehicles to end-users, greatly reducing the cost of the ride hailing service. Additionally, the remote pilot is not subject to the whims of receiving an end-user request proximal to their current location, thereby reducing down times of the remote pilot.

Likewise, for vehicle rental businesses, the remote pilot may drive the rental vehicle directly to a transit pick-up location (e.g., arrivals area of an airport, etc.) and the end-user may assume control of their rental vehicle immediately. This greatly reduces the time required for the end-user to be able to obtain and use a rental vehicle. Upon returning to a transit drop-off location (e.g., departures area of an airport, etc.), the end-user may cede control to the remote pilot for navigation to another end-user, staging area for the vehicle, or rental facility for cleaning, maintenance, or charging and/or refueling. Rather than being picked up and driven to a rental vehicle facility, the end-user is provided direct access to the rental vehicle.

Likewise, rather than having to travel to the rental vehicle facility at the end of a rental period, the end-user may simply navigate to a desired destination and the remote pilot can assume control of the vehicle for navigation back to the rental facility. While the above example is made with reference to a transit pick-up location, any pick-up location may be used (e.g., the end-user's home, work, or other desired location).

While various examples are used herein with reference to the vehicle being a car, any type of vehicle may be used without departing from the spirit and scope of this application. For example, the vehicle may be a sports utility vehicle, truck, bus, tractor trailer, boat, quadcopter, drone, helicopter, plane, or any other such vehicle.

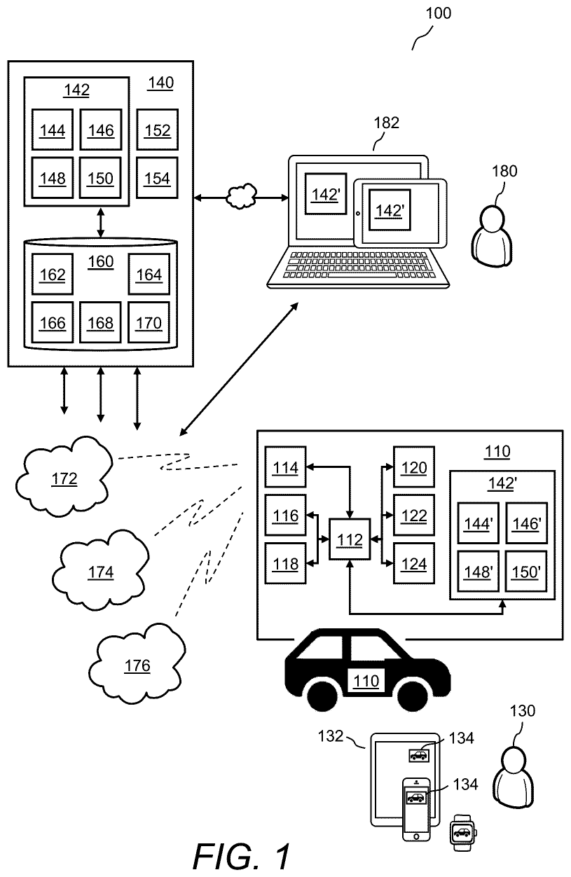

Remote Pilot and Driver Assist System Referring now to FIG. 1 is a block diagram of an example of the presently disclosed remote pilot and driver assist system 100 suitable for implementing the several embodiments of the invention. Remote pilot and driver assist system 100 may be used to facilitate safely navigating a vehicle to a desired destination. Remote pilot and driver assist system 100 may include a vehicle 110 that is drivable by a local user 130 (or end-user 130) and a remote pilot 180 using a remote pilot terminal 182. That is, vehicle 110 is equipped having capability to be driven remotely by remote pilots 180, driven autonomously using autonomous driver technology, and/or driven manually by local users 130.

In some embodiments, remote pilot and driver assist system 100 may include multiple vehicles 110, multiple local users 130 (or end-users 130), multiple remote pilots 180, and multiple remote pilot terminal 182. Local users 130 (or end-users 130) may be any persons seeking transportation from one location to another. Remote pilots 180 may be any persons associated with remote pilot and driver assist system 100 for operating and/or monitoring remotely the driving of vehicles 110 from one location to another.

In this example, remote pilot and driver assist system 100 may be provided in a networked computing configuration that includes a driver assist application 142 and a data store 160 running on an application server 140. For example, application server 140 may be accessible via a local area network (LAN) and/or a wide area network (WAN) for connecting to the Internet or to an Intranet. Application server 140 may connect to the network by any wired and/or wireless means. At application server 140, driver assist application 142 may further include a halo shield system 144, a system state arbiter 146, an emergency planner 148, and an actuation controller 150. The actuation controller 150 may alternatively be referred to as a response controller 150 or emergency response controller 150. Additionally, an authentication module 152 and a security module 154 may be running on application server 140.

Further, remote pilot data 162, end-user data 164, host vehicle data 166, vehicle sensor data 168, and system usage data 170 may be stored at data store 160. Remote pilot data 162 may include, for example, any account and/or user profile information of remote pilots 180. Remote pilot data 162 may also include records of any remote pilot commands exchanged between remote pilot terminals 182 and vehicles 110. End-user data 164 may include, for example, any account and/or user profile information of end-users 130. For example, end-user data 164 may include username, user credentials, user payment information, and the like. Host vehicle data 166 may include, for example, any information about vehicles 110 in the fleet of vehicles 110 associated with remote pilot and driver assist system 100. For example, for each vehicle 110, host vehicle data 166 may include the vehicle make, model and year; availability status; current location; maintenance status; usage history; and the like. Further, host vehicle data 166 may include a collection of host vehicle data 124 of any vehicles 110. Vehicle sensor data 168 may include, for example, a collection of sensor data 120 of any vehicles 110. The sensors may be any sensors for detecting operating conditions around the vehicle 110. For example, the sensors may include one or more of camera(s), radar, LIDAR, or other such sensors. System usage data 170 may include, for example, vehicle usage information, trip route information, trip booking information, and the like.

Authentication module 152 of driver assist application 142 may be used to manage the authentication process (e.g., username and password credentials) of any entities of remote pilot and driver assist system 100, such as end-users 130 and/or remote pilots 180.

Security module 154 of driver assist application 142 may be used to perform any system security functions with respect to keeping secure the contents of data store 160 and/or any other information with respect to remote pilot and driver assist system 100. Security module 154 may use standard security techniques, such as encryption, secure hashtags (or hash tags), and the like. Data store 160 may be, for example, data repositories (like databases) and/or flat files that can store data. Further, remote pilot and driver assist system 100 is not limited to one data store 160 only. Remote pilot and driver assist system 100 may include multiple data stores 160. Further, data store 160 may be provided on a data server that is separate from application server 140.

Local users 130 (or end-users 130) may access driver assist application 142 at application server 140 via their respective mobile devices 132. Mobile devices 132 may be any mobile computing device, such as, but not limited to, a mobile phone (or smart phone), a tablet device, a smartwatch, and the like. Similarly, remote pilots 180 may access driver assist application 142 at application server 140 via their respective remote pilot terminals 182. Remote pilot terminals 182 may be any computing device, such as, but not limited to, a desktop computer, a laptop computer, a handheld computing device, a mobile phone (or smart phone), a tablet device, and the like.

In one example, driver assist application 142 may be a software application that may be implemented as a web application and run in a web browser, such as Google Chrome or Microsoft Edge. In another example, driver assist application 142 at application server 140 may be accessible to end-users 130 and/or remote pilots 180 via a driver assist mobile app 134. In one example, driver assist mobile app 134 may be designed to operate on any device platform, including for example, Windows, Android, Apple, and the like. Further, driver assist mobile app 134 may have two operating modes, one for end-users 130 and another for remote pilots 180. Accordingly, in the end-user mode, end-users 130 may interact with the driver assist application 142 using driver assist mobile app 134 on their mobile device 132 (e.g., smart phone or tablet device). Further, in the remote pilot mode, remote pilots 180 may interact with the driver assist application 142 using driver assist mobile app 134 on their remote pilot terminals 182.

Halo shield system 144, system state arbiter 146, emergency planner 148, and actuation controller 150 of driver assist application 142 may be, for example, software components for providing a system safety platform 300 of remote pilot and driver assist system 100. More details of the system safety platform 300 of remote pilot and driver assist system 100 are shown and described hereinbelow with reference to FIG. 3 through FIG. 5.

Each of the vehicle 110 may include, for example, a driver assist controller 112, a communications interface 114, certain navigation controls 116 that produce host vehicle data 124, any arrangements and types of vehicle sensors 118 that produce sensor data 120, and autonomous driver technology 122 (or autonomous pilot 122).

Driver assist controller 112 may be any standard controller or microprocessor device that is capable of executing program instructions. Driver assist controller 112 may be used to manage the overall operations of vehicle 110 with respect to remote pilot and remote pilot and driver assist system 100. For example, driver assist controller 112 may include one or more control computers configured to receive data from vehicle sensors 118 and determine a safe route. Driver assist controller 112 monitors the local conditions from the vehicle sensors 118 and ensures that the vehicle 110 travels along a safe path. Additionally, driver assist controller 112 ensures that the vehicle travels to a minimum risk condition (e.g., pulls to the side of the road, stops in a lane, performs an emergency stop, etc.) in the event of an error, as detailed hereinbelow with reference to FIG. 6 and FIG. 7. For example, upon detecting an unsafe path, collision, communication error, or other unsafe condition, driver assist controller 112 issues commands to the navigation controls 116 to travel to a determined minimum risk condition. Driver assist controller 112 may also be configured to engage autonomous driver technology 122 for driving the vehicle 110 via the navigation controls 116.

Driver assist controller 112 may also be configured to receive, authenticate, and/or verify navigation commands (e.g., verify safety of command) received from remote pilot 180 via the communications interface 114. Upon receipt, authentication, and/or verification, the navigation commands are communicated by driver assist controller 112 to the navigation controls 116 for driving the vehicle 110. Driver assist controller 112 may also be configured to communicate vehicle conditions from the vehicle sensors 118 to the remote pilot 180 via the communications interface 114.

Communications interface 114 at application server 140 may be any wireless communication interface for connecting to a network (e.g., wireless communication networks 172, 174, 176) and by which information may be exchanged with other devices connected to the network.

Examples of wireless communication interfaces may include, but are not limited to, an cellular network connection, Intranet connection, Internet, ISM, Bluetooth® technology, Bluetooth® Low Energy (BLE) technology, Wi-Fi, Wi-Max, IEEE 402.11 technology, ZigBee technology, Z-Wave technology, 6LoWPAN technology (i.e., IPv6 over Low Power Wireless Area Network (6LoWPAN)), ANT or ANT+ (Advanced Network Tools) technology, radio frequency (RF), Infrared Data Association (IrDA) compatible protocols, Local Area Networks (LAN), Wide Area Networks (WAN), Shared Wireless Access Protocol (SWAP), any combinations thereof, and other types of wireless networking protocols.

Communications interface 114 facilitates wireless communication with a plurality of wireless communication networks. In the example shown, there is a first wireless communication network 172, a second wireless communication network 174, and a third wireless communication network 176. While three wireless communication networks are shown, additional wireless communication networks may be used. Each of the wireless communication networks is an independently operated network. For example, the first wireless communication network 172 is operated by a first telecommunications provider, the second wireless communication network 174 is operated by a second telecommunications provider, and the third wireless communication network 176 is operated by a third telecommunications provider. Wireless communication networks 172, 174, 176 may use the same or different wireless communication technologies on the same or different operating frequencies.

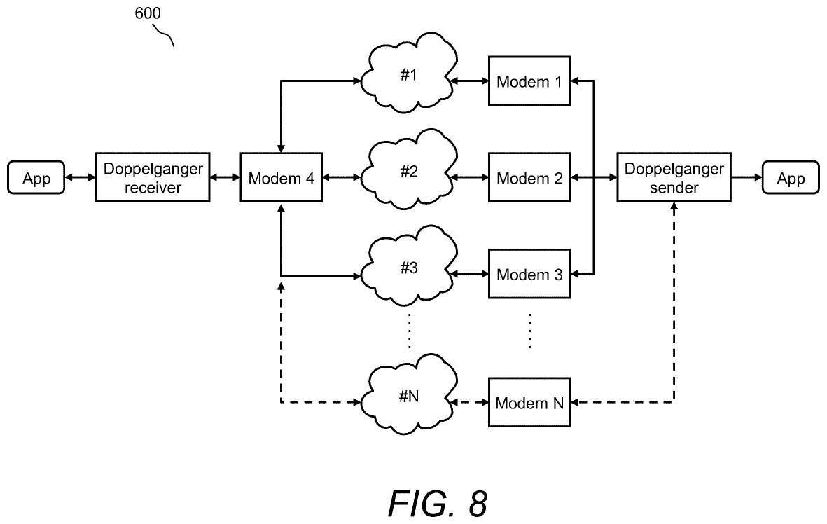

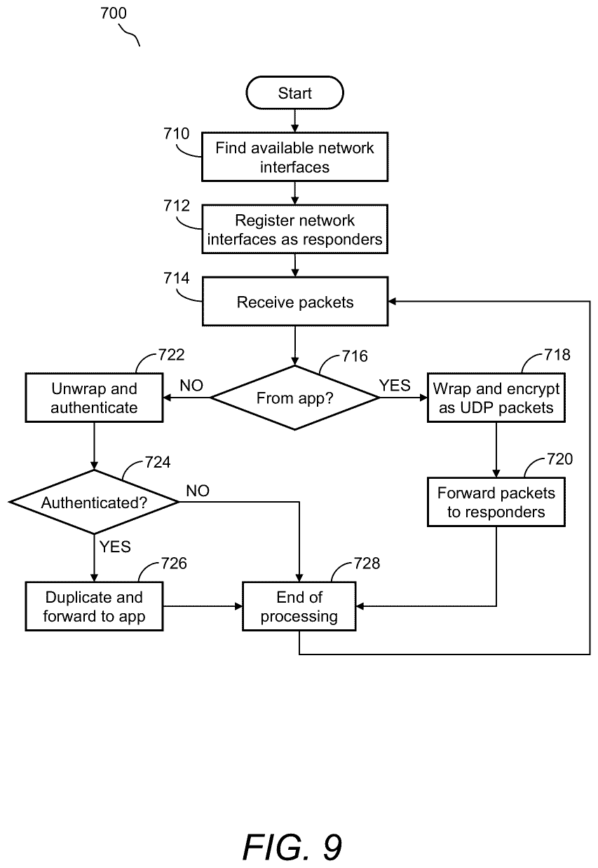

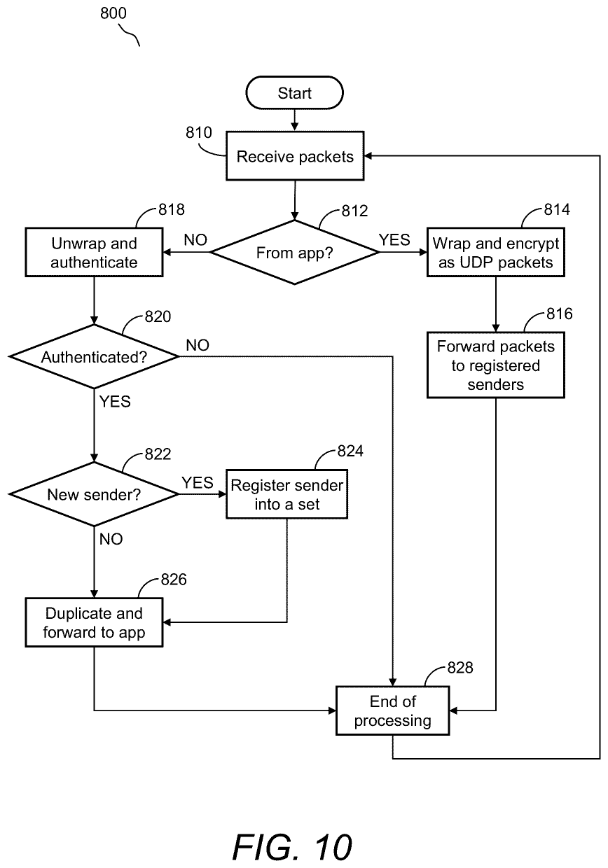

Communications interface 114 communicates via the communication networks 172, 174, 176 in a redundant round-robin fashion, as detailed hereinbelow with reference to a system safety platform doppelganger and FIG. 8, FIG. 9, and FIG. 10. The redundant round-robin communication facilitates high bandwidth and high reliability communications with the vehicle 110.

Navigation controls 116 may include one or more control systems for driving the vehicle 110. For example, for a car, the navigation controls 116 of the vehicle 110 may include the accelerator, brake, emergency break, turn signals, steering wheel, and the like. Vehicle sensors 118 may include sensors for detecting operating conditions around the vehicle 110. For example, vehicle sensors 118 may include one or more of camera(s), radar, LIDAR, or other such sensors.

The remote pilot 180 views the vehicle conditions and supplies the navigation commands via a remote pilot terminal 182. While shown as a simple computer terminal, other user interface devices may be present depending on what type of vehicle the remote pilot 180 will be driving. For example, for a car, the remote pilot terminal 182 may include a steering wheel, accelerator, break, one or more screens for displaying views of cameras and other sensor data from the vehicle sensors 118 on the vehicle 110. The remote pilot terminal 182 communicates the sensor data (e.g., vehicle sensor data 168) from the vehicle sensors 118 and the navigation commands with the vehicle 110 through application server 140 via the wireless communication networks 172, 174, 176.

In use, the end user 120 uses a mobile application on their mobile device (not shown), a website, a phone number, or any other communication method to place an order with application server 140 for a pick-up with the vehicle 110 at a pick-up location. Application server 140 identifies the vehicle 110 proximate to the pick-up location (e.g., closest available vehicle, vehicles within a predetermined distance or time of the pick-up location, etc.) and identifies an available remote pilot 180 that is authorized to drive the vehicle 110. The remote pilot 180 supplies navigation commands for driving the vehicle 110 to the pick-up location. The navigation commands are communicated to the vehicle 110 via the wireless communication networks in the redundant round robin manner described hereinbelow with reference to the system safety platform doppelganger and FIG. 8, FIG. 9, and FIG. 10. During this time, the driver assist controller 112 relays navigation commands from the remote pilot 180 to the navigation controls 116 of the vehicle 110.

Upon reaching the pick-up location, the end-user 130 enters the vehicle 110 and assumes control. For example, the end-user 114 may acknowledge control via the mobile application on their mobile device, the website, the phone number, or any other communication method with application server 140 to authorize local control of the vehicle 110 by the end-user 130. Upon application server 140 receiving acknowledgement of control by the end-user, application server 140 may communicate a control transition command to the driver assist controller 112 to allow local control of the vehicle 110 by the end-user 130.

Upon assuming control of the vehicle 110, the end-user drives the vehicle 110 to a desired destination using the navigation controls 116. Upon reaching the destination, the end-user 114 cedes control of the vehicle 110 with application server 140 to a remote pilot 180, which may be the same or different remote pilot used to drive the vehicle 110 to the pick-up location. The remote pilot 180 then drives the vehicle 110 using navigation commands communicated to the vehicle 110 via the wireless communication networks 172, 174, 176 to a staging area for a next end user or to a next pick-up location.

Referring still to FIG. 1, remote pilot and driver assist system 100 may operate in a client/server computing architecture, which is well known. In this example, driver assist application 142 at the application server 140 may be the server component of remote pilot and driver assist system 100, while driver assist mobile app 134 at each of the mobile devices 132 and/or remote pilot terminals 182 may be the client component of remote pilot and driver assist system 100. In other words, driver assist mobile app 134 at each of the mobile devices 132 is the counterpart to driver assist application 142 at application server 140. More specifically, driver assist application 142′ at vehicle 110′ (and including halo shield system 144′, system state arbiter 146′, emergency planner 148′, and actuation controller 150′) may be the counterpart to driver assist application 142 at application server 140. Similarly, driver assist application 142′ at each remote pilot terminal 182 may be the counterpart to driver assist application 142 at application server 140.

Additionally, application server 140 may be any networked computing configuration as long as it is accessible via the network by other entities of remote pilot and driver assist system 100, such as end-users 130 and remote pilots 180. For example, remote pilot and driver assist system 100, and more particularly the driver assist application 142 on application server 140, may support a cloud computing environment. In a cloud computing environment, application server 140 may be the cloud server. Further, driver assist application 142 is not limited to running on one application server 140 only. Remote pilot and driver assist system 100 may include multiple application servers 140 (or cloud servers) in order to ensure high-availability of computing resources.

Variations of the system and its operation are contemplated by this disclosure. For example, the alternative operational and use cases described above may be implemented with remote pilot and driver assist system 100.

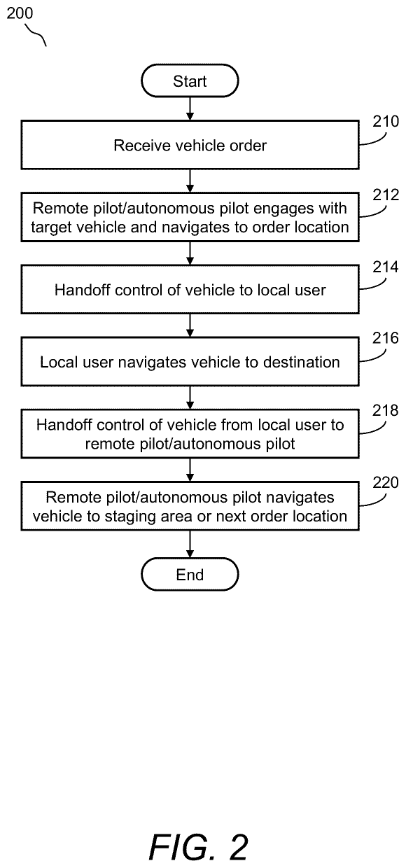

Referring now to FIG. 2 a flow diagram of an example of a method 200 of using the presently disclosed remote pilot and remote pilot and driver assist system 100, in accordance with an embodiment of the invention. Method 200 may include, but is not limited to, the following steps.

At a step 210, application server 140 receives an order for the vehicle 110. For example, an end-user 130 uses driver assist mobile app 134 to request a vehicle 110.

At a step 212, the remote pilot 180 and/or autonomous pilot (e.g., autonomous driver technology 122) engages with the vehicle 110 and drives the vehicle 110 to the pick-up location.

At a step 214, the remote pilot 180 hands off control of the vehicle 110 to the end-user 130.

Alternatively, the end-user 130 assumes control of the vehicle 110 from the remote pilot 180 via communication with application server 140.

At a step 216, the end-user 130 drives the vehicle 110 to a desired destination. At a step 218, the end-user 130 hands off control of the vehicle 110 to the remote pilot 180. For example, the end-user 130 communicates with application server 140 that control of the vehicle 110 is no longer desired.

At a step 220, the remote pilot 180 and/or autonomous pilot (e.g., autonomous driver technology 122) navigates the vehicle 110 to a staging area or next order pick-up location. Variations of the control method 200 are contemplated by this disclosure.

### System Network Configurations

Three wireless communications networks are provided between application server 140 and vehicles 110. For example, first wireless communication network 172, second wireless communication network 174, and third wireless communication network 176 may be provided for exchanging information between application server 140 and vehicles 110. Further, to optimize data processing, redundancy and therefore high network reliability may be provided by never using all three networks at the same time.

In a scenario #1, application server 140 may push data packets to all three wireless communication networks 172, 174, 176, which create three redundancies. However, the data packet that arrives at its destination first (on any one of the three networks) gets consumed, while the remaining two data packets are shutout or ignored. This is one way to ensure a reliable network connection.

In one example of scenario #1, application server 140 may push data packets to all three wireless communication networks 172, 174, 176. However, the data packet on wireless communication network 172 happens to arrive first at its destination. Accordingly, the data packet on wireless communication network 172 gets consumed, while the remaining two data packets on wireless communication networks 174 and 176 are shutout or ignored.

In another example of scenario #1, application server 140 may push data packets to all three wireless communication networks 172, 174, 176. However, the data packet on wireless communication network 174 happens to arrive first at its destination. Accordingly, the data packet on wireless communication network 174 gets consumed, while the remaining two data packets on wireless communication networks 172 and 176 are shutout or ignored.

In yet another example of scenario #1, application server 140 may push data packets to all three wireless communication networks 172, 174, 176. However, the data packet on wireless communication network 176 happens to arrive first at its destination. Accordingly, the data packet on wireless communication network 176 gets consumed, while the remaining two data packets on wireless communication networks 172 and 174 are shutout or ignored.

In a scenario #2, a round-robin process may be used to optimize data processing in remote pilot and driver assist system 100. The round-robin process of scenario #2 may be more cost effective compared with scenario #1. In this example, application server 140 may push data packets to two of the wireless communication networks 172, 174, 176, while not pushing data packets to the remaining one of the wireless communication networks 172, 174, 176. This round-robin process of scenario #2 may save, for example, about 33% of the cost compared with scenario #1. This is because scenario #2 is pushing the same data packet to two networks only instead of to all three networks. However, scenario #2 still provides redundancy and high reliability, and with the added benefit of efficiency of cost.

In one example of scenario #2, application server 140 may push the same data packet to wireless communication networks 172 and 174, while saving wireless communication network 176 (i.e., wireless communication network 176 is empty of data packets, or silent).

In another example of scenario #2, application server 140 may push the same data packet to wireless communication networks 172 and 176, while saving wireless communication network 174 (i.e., wireless communication network 174 is empty of data packets, or silent).

In yet another example of scenario #2, application server 140 may push the same data packet to wireless communication networks 174 and 176, while saving wireless communication network 172 (i.e., wireless communication network 172 is empty of data packets, or silent).

More details of the system network configurations of remote pilot and driver assist system 100 are described hereinbelow with reference to the system safety platform doppelganger shown in FIG. 8, FIG. 9, and FIG. 10.

### System Safety Platform

Halo shield system 144, system state arbiter 146, emergency planner 148, and actuation controller 150 of driver assist application 142 may be used to facilitate system safety platform 300 of remote pilot and driver assist system 100.

Generally, together the halo shield system 144, system state arbiter 146, emergency planner 148, and actuation controller 150 may employ, for example, robotic teleoperation for the purpose of providing a service for driverless relocation of passenger vehicles. Remote pilot 180 has full control of the driving system of the vehicle 110 and provides control commands to vehicle 110 via cellular connection. Vehicle 110 in turn may provide feedback to remote pilot 180 in the form of a video stream from the camera system of halo shield system 144, as well as host vehicle data 124 (speed, steering, brake, health, etc.).

Further, using halo shield system 144, system state arbiter 146, emergency planner 148, and actuation controller 150 of driver assist application 142, an added safety layer may be provided to work in tandem with the remote pilot 180. For example, system safety platform 300 may use robotic technology to predict potential future collisions and provide a warning to both the remote pilot 180 and the onboard safety system, so that actions can be taken to bring vehicle 110 to safety, as necessary.

Further to the example, halo shield system 144 may provide a safety layer in the system that uses robotic technology to detect and predict potential safety risks in the environment around vehicle 110. Using the robotic technology, halo shield system 144 fuses sensor data to provide accurate estimations of position and velocity of objects around the vehicle 110, such as, but not limited to, road vehicles, bicycles, pedestrians, and the like. These estimations are then used to predict the motion in time and space of the vehicle 110 and all surrounding objects. If any objects future path is found to intersect with that of the vehicle 110, system safety platform 300 will highlight to the broader system the potential for a collision and recommend an action.

Referring now to FIG. 3 is a high-level block diagram of an example of system safety platform 300 of remote pilot and driver assist system 100, in accordance with an embodiment of the invention. System safety platform 300 may include halo shield system 144, system state arbiter 146, emergency planner 148, and actuation controller 150 of driver assist application 142. In system safety platform 300, halo shield system 144 may supply information to system state arbiter 146. Certain input data, such as, but not limited to, vehicle sensor data 120, host vehicle data 124/166, remote pilot data 162, and environmental data 167, may supply halo shield system 144. Then, system state arbiter 146 may supply information to emergency planner 148. Then, emergency planner 148 may supply information to actuation controller 150, which supplies control information to the host vehicle 110.

Further to the example, FIG. 3 also shows pictorially an example of halo shield system 144. In halo shield system 144, vehicle 110 always has a certain perimeter or bubble around it that is being monitored by certain sensors 120. This perimeter or bubble may be, for example, a stopping distance perimeter or bubble. That is, if something unexpected happens within this perimeter, vehicle 110 may come to a full stop or take evasive measures. For example, if something is sensed within this perimeter or bubble, even if remote pilot 180 attempts to accelerate vehicle 110, the acceleration command is automatically killed to slow the car down and avoid any collisions. Halo shield system 144 may use, for example, sensor data 120 (e.g., cameras, ultrasonics, radar, LIDAR) and/or vehicle data (e.g., speed, steering angle, throttle, breaking, and the like). LIDAR means “light detection and ranging” or “laser imaging, detection, and ranging.” LIDAR is sometimes called 3-D laser scanning, a special combination of 3-D scanning and laser scanning.

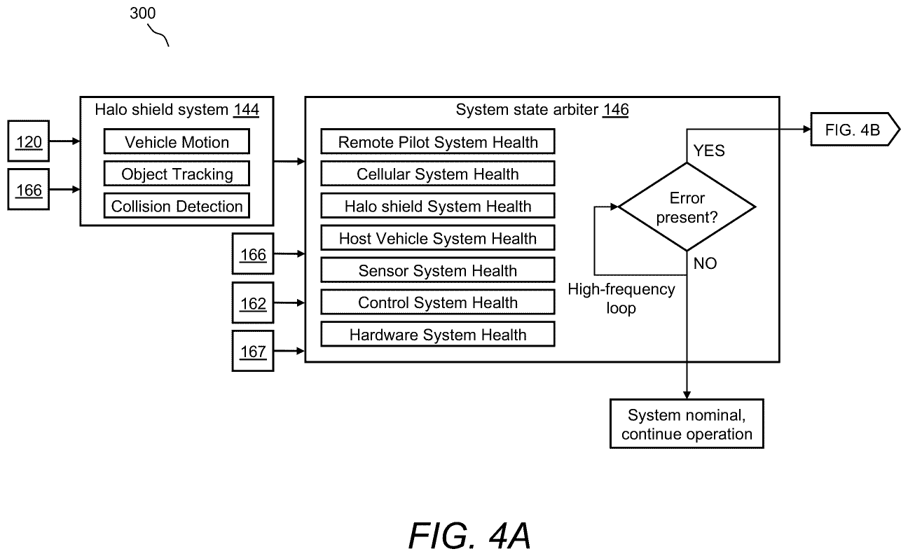

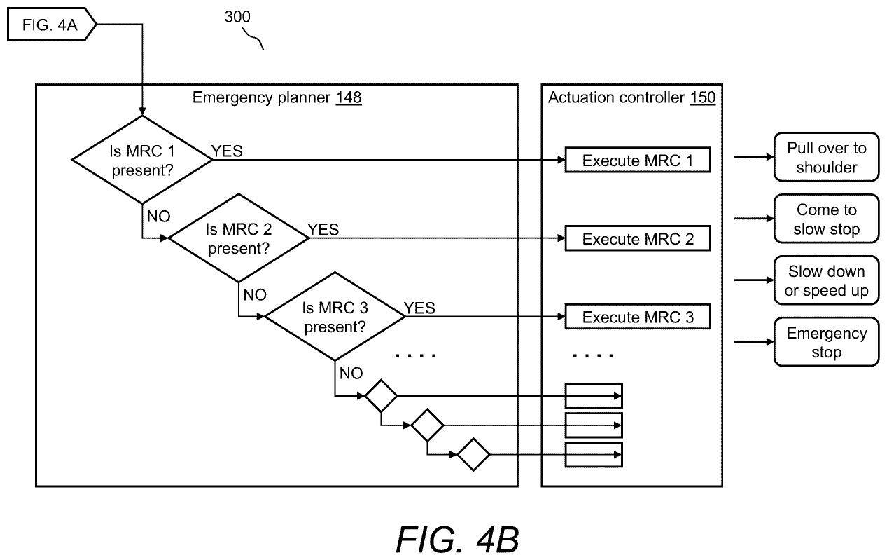

Referring now to FIG. 4A and FIG. 4B is a block diagram showing more details of the system safety platform 300 shown in FIG. 3, in accordance with an embodiment of the invention. In this example, halo shield system 144 may be informed by sensor data 120 and host vehicle data 166. In one example, sensor data 120 may include radar data, LIDAR data, camera image data, global positioning system (GPS) data, and ultrasonic data. In one example, host vehicle data 166 may include vehicle speed data, vehicle steering data, lateral acceleration data, and longitudinal acceleration data.

Additionally, halo shield system 144 may include a “vehicle motion” component, an “object tracking” component, and a “collision detection” component. The “vehicle motion” component processes vehicle speed data and vehicle steering data to, for example:
(1) generate forward path in vehicle frame,
(2) convert path to world frame, and
(3) propagate vehicle in world frame using path.

Then, the output of the “vehicle motion” component may be, for example:
(1) vehicle pose (world frame), and
(2) vehicle path (world frame).

The “object tracking” component processes sensor data 120 and the vehicle pose and vehicle path from the “vehicle motion” component, to, for example:
(1) transform radar data from radar frame to the vehicle frame and then to the world frame,
(2) cluster radar to remove duplicates,
(3) match radar measurements to existing objects, and create new objects as needed,
(4) update position of objects using newly matched measurements, and a state model (e.g., Kalman filter), and
(5) remove any extinct objects from the tracker.

Then, the output of the “object tracking” component may be, for example: (1) tracked objects (world frame).

The “collision detection” component processes the vehicle pose and vehicle path from the “vehicle motion” component, vehicle speed data, and tracked objects from the “object tracking” component to, for example:
(1) calculate a collision horizon, both in distance and in time. This horizon is where and when the vehicle would stop if the emergency brake were engaged at this instant;
(2) calculate the movement of the vehicle inside the time collision horizon;
(3) calculate the movement of any tracked objects inside the time collision horizon;
(4) generate an axis-aligned bounding box that bounds the vehicle movement during the time collision horizon;
(5) generate axis-aligned bounding boxes for each tracked object, which bound their movement;
(6) check for an intersection of the vehicle bounding box with any of the object bounding boxes;
(7) if any intersection exists: this means a collision is possible, continue with the next steps, else: stop;
(8) calculate new time step-based occupancy boxes for vehicle and the tracked object with which the AABBs overlapped. Create a box for where the vehicle and object will be for each time step (e.g., every 50 mS) up to the collision time horizon;
(9) for each time step, check for the intersection of the vehicle occupancy with the object occupancy. If they intersect, this means there will likely be a collision; and
(10) send collision warning.

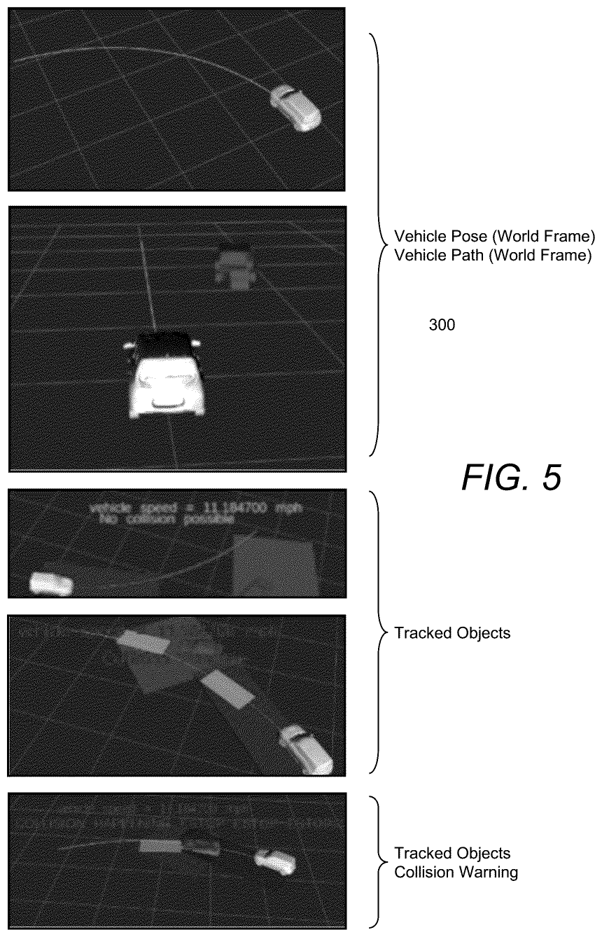

Accordingly, the output of the “collision detection” component may be, for example: (1) a collision warning. FIG. 5 shows pictorially an example of the operation and outputs of the halo shield system 144-portion of the system safety platform 300 that includes the “vehicle motion” component, the “object tracking” component, and the “collision detection” component.

Referring still to FIG. 4A and FIG. 4B, system state arbiter 146 of driver assist application 142 may be a module for monitoring the health of various systems and/or subsystems of remote pilot and driver assist system 100. For example, system state arbiter 146 may hold the logical checks to detect any system failures. System state arbiter 146 may include, for example, a “remote pilot system health” component, a “cellular system health” component, a “halo shield system health” component, a “host vehicle system health” component, a “sensor system health” component, a “control system health” component, and a “hardware system health” component. System state arbiter 146 may be used to continuously monitor for error conditions.

In remote pilot and driver assist system 100, requirements are gathered from all sub-systems regarding what is necessary or useful for each of them to function or remain in good “health.” These requirements are then used to generate logical checks inside system state arbiter 146. For example, if a requirement is no longer satisfied, system state arbiter 146 will trigger an escalation to an error state. System state arbiter 146 carries out these checks in a high frequency loop, such as a 100 Hz loop.

When no errors are present, system state arbiter 146 may, for example, indicate “system nominal, continue operation.” However, if one or more errors are present, then system state arbiter 146 may, for example, forward the one or more errors to emergency planner 148 for analysis. Then, emergency planner 148 of driver assist application 142 may process the error information and then determine the severity of the problem. For example, emergency planner 148 may determine whether certain minimum risk conditions (MRCs) exist. In one example, there may be an MRC 1, an MRC 2, and an MRC 3. However, there may be any number of MRC levels. In this example, MRC 1 may be the lowest or least severe minimum risk condition and MRC 3 may be the highest or most severe minimum risk condition. MRCs are rulesets, or behaviors that seek to bring the vehicle 110 to a position of minimal risk.

Actuation controller 150 of driver assist application 142 may continuously monitor the absence and/or presence of MRC 1, MRC 2, and MRC 3. When MRC 1 is present, then actuation controller 150 may issue a certain response command. When MRC 2 is present, then actuation controller 150 may issue a certain other response command. When MRC 3 is present, then actuation controller 150 may issue yet a certain other response command. Example response commands may include, but are not limited to, “pull over to the shoulder,” “come to a slow stop,” “slow down,” “speed up,” “take evasive action,” and “emergency stop.”

Referring now to FIG. 6 is a diagram of an example of a system safety flow timeline 400 of system safety platform 300, in accordance with an embodiment of the invention. Generally, using system safety flow timeline 400, system safety platform 300 may be used to monitor the overall health of remote pilot and driver assist system 100. System safety platform 300 exists so that, when an error does occur, it is detected, and then system safety platform 300 may respond to the error by taking action to bring the vehicle 110 to safety.

Although remote pilot and driver assist system 100 is designed to prevent errors, system safety platform 300 is designed to assume that errors will occur and then catch them. System safety flow timeline 400 is an example timeline for a failure occurrence with the system safety platform 300 in place. In one example, system safety flow timeline 400 may include a functional timeframe 410, followed by a failure timeframe 412, followed by a detection timeframe 414, followed by a mitigation timeframe 416, followed by a response timeframe 418.

During functional timeframe 410, remote pilot and driver assist system 100 is operating in a nominal state in which no failures and/or errors are present and detected. That is, here vehicle 110 may be in a fully operational state, functioning as normal, and all health checks pass.

During failure timeframe 412, a failure occurs somewhere in remote pilot and driver assist system 100. With the advent of this failure, one of the health monitoring checks inside system safety platform 300 is triggered. Halo shield system 144 operates during the failure timeframe 412.

With respect to the failure timeframe 412 of system safety flow timeline 400, more information is provided hereinbelow.

### Failure Examples

Table 1 below shows examples of failures occurring in some of the subsystems of remote pilot and driver assist system 100 that are monitored using system safety platform 300. For illustration purposes, Table 1 lists a potential cause of a failure, the effect, how the failure is detected, and then how the system may respond.

TABLE 1
examples of failures monitored using system safety playform 300

| Failed | Potential cause | Effect of | Detection | Response |
|---|---|---|---|---|
| Subsystem | of Failure | Failure | of Failure | to Failure |
| Shield system | Radar died | No longer able | Radar messages | Request remote |
| | | to detect | no longer | pilot to pull over |
| | | collisions | received | to shoulder |
| Remote pilot | Cellular | Remote pilot | Controls signals | Stop in lane |
| system | connection lost | control lost | no long received | |
| Control system | Segmentation | All control lost | Vehicle not | Emergency low |
| | fault in code | | responding to | level stop |
| | | | commands, | |
| | | | control node | |
| | | | heartbeat dead, | |
| | | | control node | |
| | | | process dies | |

### Detection Methods

There are three main categories of detection methods—Frequency, Latency, and Logic. In the frequency detection method, the detection location is the system state node. In the latency detection method, the detection location is the system state node. In the logic detection method, the detection location is inside the node that performs a function.

Frequency—A frequency detection method checks how often a piece of information is published or received. It can be very useful for detecting a wide range of problems, from connection speed to processor availability. Take for example the steering controller functionality, it needs to receive data from the remote pilot about where the wheel should be. The steering control system is designed to have a dependency on receiving 60 commands per second (60 Hz). If the commands do not enter the system at this frequency, the ability to control adequately drops.

Frequency—In the system state node, a check has been written that will raise a system error if the remote pilot steering command does not get updated for 167 milliseconds, in effect missing 10 normal update cycles of a stable 60 Hz signal, which would update every 16.6 mS normally.

Latency—A latency detection method checks how old a piece of data is. It is distinctly separate from frequency. The system may have a stable 60 Hz frequency, but if the data is 10 seconds old it's useless. Reducing latency is beneficial for enabling the remote pilot to drive the system safely.

Latency—An example of a latency check in remote pilot and driver assist system 100 is on the camera data. For example, when a frame is captured by the camera, it gets a timestamp that indicates the exact moment that the data is relevant to. As the data flows through the system, time passes. It takes time to process the camera data, resize it, pass it through an encoder and send it to the remote pilot on the network. A check on camera data records the elapsed time from image capture, to point of transmission on the network. If the elapsed time is greater than a threshold, the system state node will raise an error.

Logic—Here the term “logic” may be uses as a broad catch all for checks inside the functional nodes themselves. The system state node listens to error signals from the functional nodes that possess these checks. If a functional node has the ability to monitor its performance, then when the performance is no longer adequate, it can send a flag to the system state node.

Recovery after a Failure

In the event of a failure, system safety platform 300 of remote pilot and driver assist system 100 exists to bring the vehicle 110 to a safe stop in a suitable environment. If the failure is transient, remote pilot 180 may retake control once the system health checks return nominal. For a transient failure, the data is still heavily analyzed to determine a cause, and to prevent recurrence in the future. If the failure is persistent, there are two recovery options available.

One is recovery by a remote team, where a technician may physically go to the vehicle 110 and take control to bring vehicle 110 back to its home base. This can also sometimes require a tow truck depending on the failure. The other recovery option is a “limp home mode.” This mode is reserved for less critical failures, where the remote pilot 180 still has the ability to safely navigate vehicle 110 at low speeds. In “limp home mode” the speed limits are reduced, and system safety platform 300 continues to monitor for other errors. The remote pilot 180 will take the vehicle 110 to its home base for further diagnostics. Table 2 below shows an example of failure types and recovery methods.

TABLE 2
Example failure types and recovery methods.

| Failure type | Recovery method |
|---|---|
| Transient | Remote pilot retake control |
| Minor failure (remote pilot functional) | Limp home mode |
| Persistent significant failure | Recovery technician physically |
| | takes over the vehicle. |

During detection timeframe 414, system safety platform 300 of remote pilot and driver assist system 100 detects failure. For example, system state arbiter 146 holds the logical checks to detect any system failures. Here, the failure has been detected and by the nature of the check that was triggered, the system functionality loss in known and recognized within system safety platform 300.

With respect to the system safety flow timeline 400 shown in FIG. 6, system state arbiter 146 operates during the detection timeframe 414. System state arbiter 146 holds the logical checks to detect any system failures.

System state arbiter 146 is a node inside the system safety platform 300. System state arbiter 146 contains logic to determine what the state of the vehicle 110 should be. System state arbiter 146 is currently made up of three separate sub-states: control_state, error_state, and e stop state.

Some state differences are simple and obvious. For instance, the ‘control_state’ of the vehicle 110 can switch between ‘IN_VEI/CLE_CONTROL’ meaning that the human driver (e.g., local users 130) physically in the vehicle has control, and ‘REMOTE_PILOT_CONTROL’ where the system is responding to the commands of the remote pilot 180. A global system state can be used by all software nodes, allowing them to determine when it is appropriate to do something or not. Examples of different system states and their possible values can be found in Table 3 below.

TABLE 3
Example of different system states and their possible values.

| State | Value |
|---|---|
| control_state | IN_VEHICLE_CONTROL |
| | REMOTE_PILOT_CONTROL |
| | SYSTEM_CONTROL |
| _control_state | ERROR_FALSE |
| | ERROR_TRUE |
| stop_state | E_STOP_FALSE |
| | E_STOP_TRUE |

As the system evolves, many more states can be added to system state arbiter 146. For example, it is possible to manage the lane keeping behavior of vehicle 110 with a lane_keeping state, which might have values such as ‘centered’, ‘lean_left’, and ‘lean right’.

Another such autonomous behavior state might be ‘turning state’, which might have values such as ‘not turning’, ‘turning left’, ‘turning right’. These states can help prepare for and execute maneuvers on the road. For example, a piece of software might listen to the ‘turning state’ to know when to actuate the turn signals.

System state arbiter 146 holds the logical checks to detect any system failures. As used herein, the term “arbiter” may be used when describing this node as it holds all the logic to decide which state our system should be in. For example, it holds the final say as to whether or not an engagement request from remote pilot 180 should be allowed. Again, requirements are gathered from all sub-systems regarding what is necessary or useful for each of them to function or remain in good “health.” These requirements are then used to generate logical checks inside system state arbiter 146. For example, if a requirement is no longer satisfied, system state arbiter 146 will trigger an escalation to an error state. Referring now to FIG. 7 is a flow diagram of an example of a logic check method 500 using system state arbiter 146. Logic check method 500 may include, but is not limited to, the following steps.

At a decision step 510, system state arbiter 146 determines whether the remote pilot 180 has requested engagement. If no, then method 500 may proceed to step 512. If yes, then method 500 may proceed to step 514.

At a step 512, remote pilot and driver assist system 100 stays in the current state.

At a decision step 514, system state arbiter 146 determines whether any system errors exist that prevent engaging. If no, then method 500 may proceed to step 518. If yes, then method 500 may proceed to step 516.

At a step 516, system state arbiter 146 logs the rejected request. Then, method 500 returns to step 512.

At a step 518, system state arbiter 146 transitions the control state to REMOTE_PILOT_CONTROL and sends an engagement flag to the host vehicle 110.

Method 500 ends.

Referring now again to system safety flow timeline 400 shown in FIG. 6, during mitigation timeframe 416, system safety platform 300 of remote pilot and driver assist system 100 performs a failure analysis and determines corrective action. For example, with a part of the system functionality compromised, an algorithm is chosen from a list of known options, which are the MRCs. MRCs are thus named as they are rulesets, or behaviors that seek to bring vehicle 110 to a position of minimal risk.

For example, emergency planner 148 may determine whether an MRC 1, MRC 2, and/or MRC 3 is present and then executes commands to reach a minimum risk condition. For example, actuation controller 150 may continuously monitor the absence and/or presence of MRC 1, MRC 2, and MRC 3 and if present may issue a certain response command with the intent of reaching a certain minimum risk condition. For example, when MRC 1 is present, then actuation controller 150 may issue a certain response command. When MRC 2 is present, then actuation controller 150 may issue a certain other response command. When MRC 3 is present, then actuation controller 150 may issue yet a certain other response command. Example response commands may include, but are not limited to, “pull over to the shoulder,” “come to a slow stop,” “slow down,” “speed up,” “take evasive action,” and “emergency stop.”

With respect to the system safety flow timeline 400 shown in FIG. 6, emergency planner 148 operates during the mitigation timeframe 416. For example, emergency planner 148 comes into action once a failure has been detected by system state arbiter 146. Emergency planner 148 holds the logic to decide which MRCs are possible and decides the best MRC for the current failure situation.

MRCs are ordered according to ascending risk. An example of a low-risk MRC may be “Pull over to shoulder when safe.” This would be a suitable choice for a non-critical system error, where the system functionality for the required maneuver still exists. An example of a high-risk MRC is “emergency stop.” This is a suitable choice in the unlikely event that all normal system functionality has been lost, and the only action left is a low-level brake actuation. The higher risk level MRCs are not intrinsically safe in themselves, but this node exists to choose the safest possible action.

Further, with respect to choosing an emergency behavior, the choice of which emergency behavior is possible requires a knowledge of the full functionality of remote pilot and driver assist system 100. Remote pilot and driver assist system 100 may be thought of as an arrangement of multiple functional blocks that have been identified. A failure or error will kill one or more of these functional blocks. For example, each of the emergency behaviors has a minimal list of functional blocks it needs to safely execute. If one of these incapacitated by the error, then that emergency behavior is no longer a possibility. Table 4 below shows examples of functional blocks required to perform a certain emergency behavior.

TABLE 4
Example emergency behaviors and their required functional blocks

| (Availability) | (Operable) |
|---|---|
| Emergency Behaviors | Functional Blocks Required |
| (YES) Pull over to the shoulder | (YES) Center forward visual |
| | (YES) Right rear visual |
| | (YES) Right forward visual |
| | (YES) Cellular data transmission |
| | (YES) Remote pilot functionality |
| | (YES) Host vehicle steering |
| | (YES) Host vehicle braking |
| | (YES) Halo system health |
| (YES) Emergency stop in lane | (YES) Center forward visual |
| | (YES) Cellular data transmission |
| | (YES) Remote pilot functionality |
| | (YES) Host vehicle steering |
| | (YES) Host vehicle braking |
| | (YES) Halo system health |

By contrast, Table 5 below shows that the right rear camera is in an error state, so the “Right rear visual” block is no longer functional. Consequently, the “Pull over to the shoulder” behavior is no longer viable. Now emergency planner 148 will move to the next possible behavior, and if all of those functional blocks are working, then emergency planner 148 will execute the next possible behavior.

TABLE 5
Example emergency behaviors and their required functional blocks

| (Availability) | (Operable) |
|---|---|
| Emergency Behaviors | Functional Blocks Required |
| (NO) Pull over to the shoulder | (YES) Center forward visual |
| | (NO) Right rear visual |
| | (YES) Right forward visual |
| | (YES) Cellular data transmission |
| | (YES) Remote pilot functionality |
| | (YES) Host vehicle steering |
| | (YES) Host vehicle braking |
| | (YES) Halo system health |
| (YES) Emergency stop in lane | (YES) Center forward visual |
| | (YES) Cellular data transmission |
| | (YES) Remote pilot functionality |
| | (YES) Host vehicle steering |
| | (YES) Host vehicle braking |
| | (YES) Halo system health |

Referring now again to system safety flow timeline 400 shown in FIG. 6, during response timeframe 418, remote pilot and driver assist system 100 reaches a minimum risk condition. For example, upon executing the command issued in mitigation timeframe 416, remote pilot and driver assist system 100 may reach a certain minimum risk condition.

With respect to the system safety flow timeline 400 shown in FIG. 6, actuation controller 150 operates during the response timeframe 418.

When an error has been detected, and an MRC has been chosen (see FIG. 4B), actuation controller 150 is responsible for making vehicle 110 go where it needs to go. Actuation controller 150 controls steering, brake and throttle actuation. In normal operating conditions, actuation controller 150 is the node that keeps vehicle 110 doing what it is commanded to do. However, during an MRC execution, actuation controller 150 has a pre-programmed response specific for each MRC. Using this response, vehicle 110 will predictably perform the intended actions, and reach the desired minimum risk condition.

Additionally, depending on the specific needs of certain MRCs, actuation controller 150 may take different actions. Some examples are:
For an emergency stop, actuation controller 150 may trigger hazard lights, and apply brake pressure to obtain a predetermined deceleration rate until the vehicle stops. Then, actuation controller 150 may apply a brake pressure to hold vehicle 110 stationary.
For a stop in lane, actuation controller 150 may trigger hazard lights and actuate the steering wheel to keep vehicle 110 in lane, while also applying brake pressure to obtain a (different than emergency) predetermined deceleration rate. Then, once stopped actuation controller 150 may apply a brake pressure to hold vehicle 110 stationary.
For a pull over to the shoulder maneuver, actuation controller 150 may trigger the turn signal, and actuate the steering wheel to move vehicle 110 across to the shoulder of the road, and when suitable, apply brake pressure to bring vehicle 110 to a stop. Then, actuation controller 150 may apply a brake pressure to hold vehicle 110 stationary.

### System Safety Platform Doppelganger

The presently disclosed remote pilot and driver assist system 100 may take advantage of certain network configurations tailored for redundant and available networks in mobile environments, such as those in remote pilot and driver assist system 100. For example, network configurations of remote pilot and driver assist system 100 may include a hybrid network bonding approach that can improve network redundancy and availability by using multiple network paths in mobile environments.

Real-time video/audio streaming applications require stable latency and enough bandwidth to forward the packets. In a stationary environment, latency and bandwidth are somewhat predictable, the signal strength from a device to Wi-Fi doesn't change much, and even less so if the device is wired. Whereas in a mobile environment, signal strength can drop at any time depending on how far the device is from many factors such as nearby antennas, surrounding interference. In critical real time systems, such as robotic teleoperation, small latency spikes can cause safety hazards, preventing the remote pilot from operating the vehicle safely in some scenarios.

Currently, there are many third-party solutions that can improve network redundancy or availability, but none of them can improve both latency and throughput. Accordingly, remote pilot and driver assist system 100 incorporates a hybrid approach that can improve both redundancy and availability by having at least three network connections, as shown, for example, in FIG. 1. Table 6 below shows a trade-off table between each approach.

TABLE 6
Comparison Overview

| | | | | Hybrid |
|---|---|---|---|---|
| | Single | Availability | | (round- |
| Network | Network | (round- | Redundant | robin and |
| Aspect | Connection | robin) | (broadcast) | broadcast) |
| Throughput | Lowest | Highest | Lowest | Medium |
| Reliability | Lowest | Lowest | Highest | Medium |
| Bandwidth | Lowest | Lowest | Highest | Medium |
| Cost | | | | |
| #Min Network | 1 | 2 | 2 | 3 |
| Connections | | | | |

Having a minimum network connection of three for a hybrid mode, allows packets to be broadcasted to multiple networks to ensure redundancy, while trading off some of its redundancy with throughput and cost in a round-robin manner (broadcast to some, but not all networks). Although a hybrid approach may not provide optimal network throughput and reliability, it may be the most balanced trade-off across Table 6. Therefore, it may be a suitable model for a mobile environment, such as in remote pilot and driver assist system 100, where bad factors (signal strength, network congestion, lossy network, etc.) keep changing depending on the location.

### Implementation

As implemented herein, the network program may be called “doppelganger” (dopp for short). dopp sits in between the application and the network. dopp provides a virtual IP to give a transparent interface to the application layer, essentially works as a VPN. dopp doesn't have a restriction on the number of network connections, however, having at least three network connections is required to enable hybrid mode. Same packets will be seen coming from different IP addresses on the receiver end as they are transported by different networks, dopp then authenticate and authorize these packets similar to any other VPNs, and deduplicate them in FIFO way (first-in-first-out).

Referring now to FIG. 8 is a block diagram of an example of an overall network architecture 600 of remote pilot and driver assist system 100. The overall network architecture 600 may include, for example, a doppelganger receiver; 1 through N networks, but with at least three networks; and a doppelganger sender.

### Sender Loop

dopp is designed to handle an arbitrary number of network interfaces. It achieves this by having a light background thread to keep checking available network interfaces that are usable to send/receive packets and matched with the configured regex pattern every 1 second. These network interfaces are then stored internally to forward the packets from the app in the main thread as responders.

Because dopp works as a VPN, there are two sources of packets: applications and the internet. When the sender receives packets from the applications, dopp receives packets as layer 3 raw packets (In Linux, a TUN interface can be used to create a virtual IP for applications in user space), which allows dopp to be compatible with any layer 3 or above applications, such as ping, http, ssh, rtp, etc. Another big benefit of having access to layer 3 raw packets is that dopp can be engineered to understand packets and use this knowledge for enhancing the scheduling algorithm in the future, for example, QoS that prioritizes RTP packets.

To ensure the lowest overhead for most applications, especially real time video/audio streaming for the halo shield system 144 (or generally the system safety platform 300), dopp uses UDP to forward layer 3 raw packets to the receiver end. UDP gives us the leanest overhead for our needs while still well supported on most operating systems without tapping into the kernel space. Because UDP doesn't guarantee reliability and order, dopp passes these responsibilities to the application layer. Not only does it reduce the implementation complexity, but it also allows better performance for the application, for example, packets won't be retransmitted unnecessarily when applications such as real time video/audio streaming are tolerant to some packet loss or reordering. Additionally, dopp prepends some headers for authentication, authorization, and metadata that is used for telemetry on the receiver end. The wrapped packets are then forwarded to the receiver through the responders, registered automatically in the discovery background thread.

Referring now to FIG. 9 is a flow diagram of an example of a sender loop 700 that may be used in the network configuration of remote pilot and driver assist system 100. In sender loop 700, when the sender receives UDP packets from the internet, the sender authenticates, authorizes, unwraps, and deduplicates the packets. Sender loop 700 may include, but is not limited to, the following steps.

At a step 710, the available network interfaces are found or discovered. Sender loop 700 proceeds to step 712.

At a step 712, the network interfaces are registered as doppelganger responders. Sender loop 700 proceeds to step 714.

At a step 714, packets are received by the doppelganger responders. Sender loop 700 proceeds to step 716.

At a decision step 716, it is determined whether the packets are from the app, such as from driver assist mobile app 134 and/or from a remote pilot terminal 182. If yes, then sender loop 700 proceeds to step 718. If no, then sender loop 700 proceeds to step 722.

At a step 718, the packets are wrapped and encrypted as user datagram protocol (UDP) packets. Sender loop 700 proceeds to step 720.

At a step 720, the packets are forwarded to the doppelganger responders. Sender loop 700 proceeds to step 728.

At a step 722, the packets are unwrapped and authenticated. Sender loop 700 proceeds to step 724.

At a decision step 724, it is determined whether the packets are authenticated. If yes, then sender loop 700 proceeds to step 726. If no, then sender loop 700 proceeds to step 728.

At a step 726, the packets are duplicated and forwarded to the app, such as to driver assist mobile app 134 and/or to a remote pilot terminal 182. Sender loop 700 proceeds to step 728.

At a step 728, processing ends for a certain packet. However, steps 714 through 728 of sender loop 700 may be repeated for any subsequent packets.

### Receiver Loop

The implementation of the receiver loop is almost identical to the sender loop. The main difference is that the receiver does not have a background thread for a network interface discovery. Rather, it receives the sender endpoints by extracting the IP and port from incoming UDP packets.

Referring now to FIG. 10 is a flow diagram of an example of a receiver loop 800 that may be used in the network configuration of remote pilot and driver assist system 100. In receiver loop 800, to keep the incoming UDP IP and port pairs open, the sender is required to send a keep-alive message every 15 seconds so that the NAT bindings are kept alive for the session. Because UDP is stateless, the receiver has an internal bookkeeping data structure that records the TTL of every IP and port pair. For every 1 second, a background thread iterates each pair in the data structure and removes all staled pairs. Receiver loop 800 may include, but is not limited to, the following steps.

At a step 810, packets are received by the doppelganger responders. Receiver loop 800 proceeds to step 812.

At a decision step 812, it is determined whether the packets are from the app, such as from driver assist mobile app 134 and/or from a remote pilot terminal 182. If yes, then receiver loop 800 proceeds to step 814. If no, then receiver loop 800 proceeds to step 818.

At a step 814, the packets are wrapped and encrypted as user datagram protocol (UDP) packets. Receiver loop 800 proceeds to step 816.

At a step 816, the packets are forwarded to the doppelganger registered responders.

Receiver loop 800 proceeds to step 828.

At a step 818, the packets are unwrapped and authenticated. Receiver loop 800 proceeds to step 824.

At a decision step 820, it is determined whether the packets are authenticated. If yes, then receiver loop 800 proceeds to step 822. If now, then receiver loop 800 proceeds to step 828.

At a decision step 822, it is determined whether the sender is a new sender. If yes, then receiver loop 800 proceeds to step 824. If no, then receiver loop 800 proceeds to step 826.

At a step 826, the packets are duplicated and forwarded to the app, such as to driver assist mobile app 134 and/or to a remote pilot terminal 182. Receiver loop 800 proceeds to step 828.

At a step 828, processing ends for a certain packet. However, steps 814 through 828 of receiver loop 800 may be repeated for any subsequent packets.

Packet Distribution Because the receiving end deduplicates incoming packets at all times in a FIFO manner (first in first out), there is no difference between broadcasting packets to three network connections vs. a single network connection. Thus, the sending end is able to decide to decrease/increase the number of responders to broadcast from at any moment without negotiating the change. This brings up a unique property where dopp may be configured to be in availability (round-robin), hybrid (round-robin and broadcast), and redundant (broadcast) modes with a single parameter BROADCAST_N, a parameter that determines the maximum number of responders to forward a packet at any moment. When BROADCAST_N is set to 1, dopp is set to availability mode, whereas 0 or #available network connections means redundant mode, and anything between is a hybrid mode.

For example, remote pilot and driver assist system 100 may include three available network interfaces as our responders and BROADCAST_N=2. Table 7 below shows how packets may get distributed over time, each sequence number represents a single packet and same packet is forwarded to multiple network connections if they are multiple “O” in the same row:

TABLE 7
Example Hybrid Packet Flow

| | Network | Network | Network |
|---|---|---|---|
| Sequence | Connection 1 | Connection 2 | Connection 3 |
| 0 | ◯ | ◯ | — |
| 1 | — | ◯ | ◯ |
| 2 | ◯ | — | ◯ |
| 3 | ◯ | ◯ | — |

Symbols: “◯”: used to forward a packet; “—”: skipped

Another benefit, dopp will automatically switch to the redundant mode when the number of available network interfaces drops to less than or equal to BROADCAST_N. This also means that dopp always prioritizes redundancy over availability. Table 8 below shows a scenario using the same setup as the previous example where one of the network interfaces suddenly fails:

TABLE 8
Example Hybrid Packet Flow with a Failure

| | Network | Network | Network |
|---|---|---|---|
| Sequence | Connection 1 | Connection 2 | Connection 3 |
| 0 | ◯ | ◯ | — |
| 1 (network | — | ◯ | X |
| connection 3 | | | |
| fails) | | | |
| 2 | ◯ | ◯ | — |
| 3 | ◯ | ◯ | — |

Symbols: “X”: failed to forward a packet

Table 8 shows that network connection 3 fails while sending packet sequence 1. Because the packet is still broadcasted to network connection 2, the receiver is still able to receive the packet. As soon as the network failure is detected, network connection is removed from responders and dopp fallbacks to broadcast mode with 2 network connections.

### Evaluation

In relative to a single network connection, network throughput, reliability, and bandwidth cost can be calculated by the following formula:

Throughput: #network_connections/BROADCAST_N*original_throughput

Reliability: BROADCAST_N*original_reliability

Bandwidth Cost: BROADCAST_N*original_cost

Using these calculations, the theoretical gain relative to the following single network connection specifications can be calculated:
Throughput: 2 Mbps
Reliability: 1
Bandwidth Cost: $3/Gb

TABLE 9
Benchmark Comparison

| BROADCAST_N | Throughput | Reliability | Bandwidth Cost |
|---|---|---|---|
| 1 (availability) | 6 Mbps | 1x | $3/Gb |
| 2 (hybrid) | 4 Mbps | 2x | $6/Gb |
| 3 (redundant) | 2 Mbps | 3x | $9/Gb |

In remote pilot and driver assist system 100, each vehicle 110 may approximately serve about 60 trips per day with each trip taking about 10 minutes. In a month, with about 5 Mbps bandwidth usage per modem, broadcasting to 3 modems would consume about 1.977 TB. Whereas in hybrid mode, the bandwidth usage may be reduced to about 1.318 TB, which translates to saving about 659.17 GB/month.

### CONCLUSION

In a mobile environment, such as that of remote pilot and driver assist system 100, signal strength and network congestion tend to vary depending on the location. Because these factors are outside of our control and unpredictable, it is ideal to create a system that can handle the reasonable worst-case scenario of all times and locations.

This may not be achieved by choosing either availability or redundant mode because choosing one of the others means that the system is making an assumption that it won't face an availability or a redundancy problem. For example, if the system is set to availability mode, it means that the system makes an assumption that all network connections will have a connection to the internet provider, which is not the worst case because the connection can switch to another tower for a short time. Whereas, if the system is set to redundant mode, the system assumes that there is always a single network connection that has good signal strength, which is also not true because it is possible that the system is surrounded by high interference devices.

Although hybrid mode may not solve all of the network connectivity problems, it has the most balanced performance among the other modes. In other words, a hybrid system is optimized to reduce the worst-case scenario.

In summary and referring now again to FIG. 1 through FIG. 10, the presently disclosed remote pilot and driver assist system 100 may be used to safely navigate a vehicle 110 to a desired destination. A remote pilot 180 may maintain primary control over vehicle 110 using his/her remote pilot terminal 182 that is in communication with navigation controls 116 of the vehicle 110. Using the navigation controls 116 of the vehicle 110, the remote pilot 180 may drive the vehicle 110 to a pick-up location of an end-user 130. Remote pilot and driver assist system 100 monitors the local conditions and ensures that the remote pilot 180 travels along a safe path. Remote pilot and driver assist system 100 drives the vehicle 110 to a minimum risk condition (MRC) in the event of an error. For known autonomously safe sections of a route between a current location of the vehicle 110 and the pick-up location, autonomous driver technology 122 (or autonomous pilot 122) may maintain primary control of the vehicle 110 while the remote pilot 1180 supervises. On more difficult sections of the route or at will, the remote pilot 180 may take primary control of the vehicle 110 from the autonomous pilot 122.

It should be appreciated that the logical operations described herein with respect to the various drawings may be implemented (1) as a sequence of computer implemented acts or program modules (i.e., software) running on a computing device, (2) as interconnected machine logic circuits or circuit modules (i.e., hardware) within the computing device and/or (3) a combination of software and hardware of the computing device. Thus, the logical operations discussed herein are not limited to any specific combination of hardware and software. The implementation is a matter of choice dependent on the performance and other requirements of the computing device. Accordingly, the logical operations described herein are referred to variously as operations, structural devices, acts, or modules. These operations, structural devices, acts and modules may be implemented in software, in firmware, in special purpose digital logic, and any combination thereof. It should also be appreciated that more or fewer operations may be performed than shown in the drawings and described herein. These operations may also be performed in a different order than those described herein.

Following long-standing patent law convention, the terms “a,” “an,” and “the” refer to “one or more” when used in this application, including the claims. Thus, for example, reference to “a subject” includes a plurality of subjects, unless the context clearly is to the contrary (e.g., a plurality of subjects), and so forth.

The terms “comprise,” “comprises,” “comprising,” “include,” “includes,” and “including,” are intended to be non-limiting, such that recitation of items in a list is not to the exclusion of other like items that may be substituted or added to the listed items.

Terms like “preferably,” “commonly,” and “typically” are not utilized herein to limit the scope of the claimed embodiments or to imply that certain features are critical or essential to the structure or function of the claimed embodiments. These terms are intended to highlight alternative or additional features that may or may not be utilized in a particular embodiment of the present disclosure.

The term “substantially” is utilized herein to represent the inherent degree of uncertainty that may be attributed to any quantitative comparison, value, measurement, or other representation and to represent the degree by which a quantitative representation may vary from a stated reference without resulting in a change in the basic function of the subject matter at issue.

The present invention may be implemented using hardware, software, or a combination thereof and may be implemented in one or more computer systems or other processing systems. In one aspect, the invention is directed toward one or more computer systems capable of carrying out the functionality described herein.

Various modifications and variations of the disclosed methods, compositions and uses of the invention will be apparent to the skilled person without departing from the scope and spirit of the invention. Although the invention has been disclosed in connection with specific preferred aspects or embodiments, it should be understood that the invention as claimed should not be unduly limited to such specific aspects or embodiments.

Further, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range.

Although the foregoing subject matter has been described in some detail by way of illustration and example for purposes of clarity of understanding, it will be understood by those skilled in the art that certain changes and modifications can be practiced within the scope of the appended claims.

That which is claimed:

1. A method of remotely and locally driving a vehicle, comprising:
receiving, by the vehicle, remote navigation commands from a remote pilot terminal;
controlling one or more navigation controls on the vehicle using the remote navigation commands;
transitioning from remote navigation control from the remote pilot terminal to local user control of the vehicle; and
upon transitioning to local user control, receiving manual control of the one or more navigation controls on the vehicle from the local user.

2. The method of claim 1, further comprising:
authenticating and/or verifying the remote navigation commands prior to controlling the one or more navigation controls on the vehicle using the remote navigation commands.

3. The method of claim 1, further comprising:
remotely driving the vehicle while sensing, via one or more sensors on the vehicle, an environment surrounding the vehicle; and
locally determining by the vehicle, with a driver assist system, whether the vehicle is traveling along a safe path.

4. The method of claim 3, further comprising:
upon identification of an error, controlling, by the driver assist system, the one or more navigation controls on the vehicle to a minimum risk condition.

5. The method of claim 4, wherein the error is selected from the group consisting of:
detecting an unsafe path, detecting an impending collision, detecting a communication error, detecting an error in one or more of the sensors, and detecting an obstacle in a planned path.

6. The method of claim 4, wherein the minimum risk condition is selected from the group consisting of: pulling the vehicle to the side of a road, stopping the vehicle in a lane, performing an emergency stop with the vehicle, and steering the vehicle around an obstacle.

7. The method of claim 3, further comprising:
communicating data regarding the environment surrounding the vehicle sense by the one or more sensors to the remote pilot terminal.

8. The method of claim 7, wherein the data regarding the environment surrounding the vehicle is communicated via redundant round-robin communication across a plurality of independent wireless communication networks.

9. The method of claim 1, further comprising:
after transitioning to local user control, transitioning back to remote navigation control from a second remote pilot terminal.

10. The method of claim 9, wherein the second remote pilot terminal is the same as the remote pilot terminal.

11. A locally and remotely controlled vehicle, comprising:
a modem configured to communicate with a server via a plurality of independent communication networks;
a plurality of sensors configured to detect an environment surrounding the vehicle;
navigation controls configured to drive the vehicle, wherein the navigation controls are selectively controlled based on local user inputs or remote navigation commands; and
a controller communicatively coupled to the modem, the plurality of sensors, and the navigation controls; the controller configured to:
communicate data from the sensors of the environment surrounding the vehicle to a remote pilot terminal in communication with the server;
receive the navigation controls from the remote pilot terminal; and
receive a control transition command from the server to allow local control of the navigation controls.
